(19) United States
(12) Patent Application Publication
(10) Pub. No.: US 2026/0319668 A1
(43) Pub. Date: Oct. 15, 2026

(54) CONVERTING A FIRST TYPE OF MEMORY BLOCK TO A SECOND TYPE OF MEMORY BLOCK WHILE BYPASSING AN ERASE OPERATION

(71) Applicant: Sandisk Technologies, Inc., Milpitas, CA (US)

(72) Inventors: Snehal Vithal Uphale, Bengalore (IN); Ramanathan Muthiah, Bengalore (IN); Vimal Kumar Jain, Bengalore (IN)

(21) Appl. No.: 19/174,501

(22) Filed: Apr. 9, 2025

(51) Int. Cl. G06F 3/06

(52) U.S. Cl. CPC G06F 3/0616; G06F 3/064; G06F 3/0679

(57) ABSTRACT

A data storage device includes a memory block conversion system that converts a hybrid memory block from a first type of memory block to a second type of memory block without performing an erase operation. The conversion process occurs after data has been written to the first type of memory block. During the conversion process, the data in the first type of memory block is considered as a first page of the second type of memory block and is stored in a first latch. Remaining pages of the second type of memory block are filled with additional data stored in additional latches associated with the second type of memory block. A second type of memory block programming operation is then performed on the first type of memory block using a voltage level specified by an encoding table.

### BACKGROUND

Hybrid memory blocks are memory blocks of a data storage device that can be used as single-level cell (SLC) memory blocks or triple-level cell (TLC) memory blocks. Typically, the hybrid memory blocks are used as SLC memory blocks when data is frequently read and/or written. However, if more capacity is required by the data storage device, the hybrid memory blocks, including hybrid memory blocks that have been allocated as SLC memory blocks, are converted to TLC memory blocks.

When the SLC memory blocks are converted to TLC memory blocks, data stored in the SLC memory blocks is moved to a destination memory block, such as a TLC memory block. An erase operation is performed on the SLC memory block and the newly erased memory block is returned to a TLC/hybrid memory block pool. The newly erased memory block can then be converted and/or used as a TLC memory block.

However, each erase operation that is performed on a memory block takes a certain amount of time to complete, which increases the latency of the data storage device. Additionally, each erase cycle increases an erase count of the memory block, which negatively impacts the durability of the memory block and the data storage device as a whole.

Accordingly, it would be beneficial for hybrid memory blocks to be converted from SLC memory blocks to TLC memory blocks without being subjected to the drawbacks of erase operations.

### SUMMARY

The present application describes a data storage device, such as a NAND data storage device, having a memory block conversion system. In an example, the memory block conversion system is operable to convert a hybrid memory block from a first mode, such as a hybrid single-level cell (hSLC) mode (or from a hSLC memory block), to second mode, such as a triple-level cell (TLC) mode (or a TLC memory block), without performing an erase operation. Although conversion from a hSLC memory block to a TLC memory block is specifically mentioned, the hSLC memory block may be converted to a multi-level cell (MLC) memory block, a quad-level cell (QLC) memory block, a penta-level cell (PLC) memory block and so on.

As will be explained in greater detail herein, when data is received from a host device, the data is stored in a hSLC memory block using a first programming operation or write operation. The first programming operation is performed using a first voltage level. In an example, the first voltage level has a voltage distribution curve that does not overlap a particular voltage distribution curve of a programming operation that is part of a TLC encoding scheme. For example, a voltage distribution curve V_{t_0} that is used as part of a hSLC programming operation to store a zero “0” bit in a SLC memory cell of a hSLC memory block does not overlap a voltage distribution curve V_{t_D}. After data is written to the hSLC memory block using the first voltage level, the hSLC memory block may be directly converted to a TLC memory block without relocating the data from the hSLC memory block and without performing an erase operation on the hSLC memory block.

For example, after data has been written to the hSLC memory block using the first voltage level, and the hSLC memory block is being converted to a TLC memory block, the data in one or more SLC memory cells of the hSLC memory block is considered to be an upper page of one or more TLC memory cells in a TLC memory block. As such, the memory block conversion system stores or provides the data in the SLC memory cells of the hSLC memory block to a first latch (or an upper page latch) associated with one or more TLC memory cells. To fill the remaining pages (e.g., the middle page and the lower page) of the TLC memory cell, the memory block conversion system fetches data (e.g., from a cache) for the two additional pages. When the data is retrieved, the data is stored in, or provided to, a second latch and a third latch (or a middle page latch and a lower page latch) of one or more TLC memory cells of the TLC memory block.

The memory block conversion system then issues a second programming operation or a TLC programming operation. The second programming operation uses a predefined encoding scheme having corresponding voltage levels. In an example, the predefined encoding scheme defines various voltages, or voltage distribution curves, that are used to, or are otherwise associated with, different three bit value representations. In an example, the TLC programming operation is one in which a voltage distribution curve of the first voltage is moved to the right (e.g., an increase in voltage).

As a result, the data that is stored in the hSLC memory block and the newly received data form three pages in the newly converted TLC memory block. In an example, the data that was stored in the hSLC memory block (now the upper page of one or more TLC memory cells in the TLC memory block) is separately readable from the data that was stored in the middle page and the lower page of the TLC memory cells of the TLC memory block.

Accordingly, examples of the present disclosure describe a method that includes receiving first data from a host device and writing the first data to a first type of memory block using a first voltage level. The method also includes receiving second data from the host device. Based, at least in part, on receiving the second data, the first type of memory block is converted to a second type of memory block while bypassing an erase operation on the first type of memory block. The first type of memory block is converted to the second type of memory block by determining a value of the first data in the first type of memory block, appending at least one additional value associated with the second data to the value of the first data and writing the second data to the second type of memory block by shifting the first voltage level to a second voltage level.

The present application also describes a data storage device having a controller and a memory block conversion system. The memory block conversion system is operable to write data to a memory block operating in a first mode using a first voltage level and bypass an erase operation while converting the memory block operating in the first mode to a memory block operating in a second mode, wherein the memory block conversion system converts the memory block operating in the first mode to the memory block operating in the second mode by storing a value associated with the data in a first latch associated with the memory block operating in the second mode, storing at least one additional value associated with additional data to a second latch associated with the memory block operating in the second mode and programming the additional data to the memory block operating in the second mode by shifting the first voltage level to a second voltage level.

Still other examples describe a data storage device that includes a means for receiving first data from a host device and a means for writing the first data to a first type of memory block using a first voltage level. The data storage device also includes a means for receiving second data from the host device a means for converting the first type of memory block to a second type memory block while bypassing an erase operation on the first type of memory block. In an example, the means for converting includes a means for determining a value of the first data in the first type of memory block and a means for appending at least one additional value associated with the second data to the value of the first data. The data storage device also includes a means for writing the second data to the second type of memory block. In an example, the means for writing is operable to shift the first voltage level to a second voltage level.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of a system that includes a host device and a data storage device according to an example.

FIG. 2A illustrates how a memory device includes a number of memory blocks according to an example.

FIG. 2B illustrates how a memory block includes one or more pages according to an example.

FIG. 3 illustrates a memory device having different types of memory blocks according to an example.

FIG. 4A illustrates a voltage distribution curve for a SLC memory cell according to an example.

FIG. 4B illustrates a voltage distribution curve for a TLC memory cell according to an example.

FIG. 4C illustrates a combined voltage distribution curve of SLC memory cells and TLC memory cells according to an example.

FIG. 5 illustrates data from a SLC memory cell and additional data being stored in various latches associated with a TLC memory block according to an example.

FIG. 6 illustrates an encoding table for programming a TLC memory block according to an example.

FIG. 7A illustrates how a first voltage level is shifted to a second voltage level based on information in an encoding table according to an example.

FIG. 7B illustrates how a first voltage level is shifted to a second voltage level based on information in an encoding table according to another example.

FIG. 8 illustrates a method for converting a hSLC memory block to a TLC memory block without performing an erase operation according to an example.

FIG. 9 is a perspective view of a storage device that includes three-dimensional (3D) stacked non-volatile memory according to an example.

FIG. 10 is a block diagram of a storage device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

As previously described, hybrid memory blocks are memory blocks of a data storage device that can be used as single-level cell (SLC) memory blocks or triple-level cell (TLC) memory blocks. Hybrid memory blocks are typically used as SLC memory blocks when data is frequently read and/or written. On the other hand, hybrid memory blocks are used as TLC memory blocks when more capacity is needed.

Typically, when a SLC memory block is converted to a TLC memory block, any data that is stored in the SLC memory block is moved to a destination memory block. An erase operation is then performed on the SLC memory block and the newly erased memory block is returned to a TLC/hybrid memory block pool. Hybrid memory blocks in the TLC/hybrid memory block pool may then be used as TLC memory blocks.

However, each erase operation that is performed on a memory block takes a certain amount of time to complete, which may increase the latency of the data storage device. Additionally, each erase cycle increases an erase count of the memory block, which negatively impacts the durability of the memory block and the data storage device as a whole.

To address the above, the present disclosure describes a data storage device, such as a NAND data storage device, having a memory block conversion system. The memory block conversion system is operable to convert a hybrid memory block from a first mode, or from a first type of memory block, such as a hybrid single-level cell (hSLC) mode or a hSLC memory block, to second mode, or to a second type of memory block, such as a triple-level cell (TLC) mode or a TLC memory block, without performing an erase operation. In addition to converting the hSLC memory block to a TLC memory block, data that is initially stored in the hSLC memory block is readable after the initial programming operation and is still separately readable from the additional data that is stored in the TLC memory block after the hSLC memory block has been converted to the TLC memory block.

For example, when data is received from a host device, the data is stored in a hSLC memory block. As such, a hSLC programming operation is performed using a first voltage level (e.g., Vt). In an example, the first voltage level has a voltage distribution curve that does not overlap with a voltage distribution curve of a particular voltage level of a TLC programming operation (e.g., V_{t_ER} or V_{t_D}).

After the data has been stored in the hSLC memory block, the hSLC memory block can be directly converted to TLC memory block by appending additional data to the data stored in the hSLC memory block. For example, the data stored in the hSLC memory block is read and stored in a latch associated with an upper page of one or more TLC memory cells associated with a TLC memory block. Any new data that is to be stored in the converted TLC memory block is read from a cache and stored in a latch associated with a middle page of the TLC memory cells of the TLC memory block and a latch associated with a lower page of the TLC memory cells of the TLC memory block. A TLC programming operation is then performed by shifting the first voltage level to a second voltage level.

In an example, the voltage levels are defined by a TLC encoding table. The hSLC memory block is converted to the TLC memory block without preforming an intermediate erase operation. Additionally, the data stored in the hSLC memory block is readable prior to the conversion and is also readable after the conversion.

Accordingly, many technical benefits may be realized including, but not limited to, eliminating an erase time of a memory block by allowing the memory block to be appended with logical pages on top of existing pages; avoiding relocation workloads which increases performance characteristics of the data storage device; and reducing a number of program/erase (P/E) cycles which improves the overall health of the data storage device and improves the quality of service (QoS) of the data storage device.

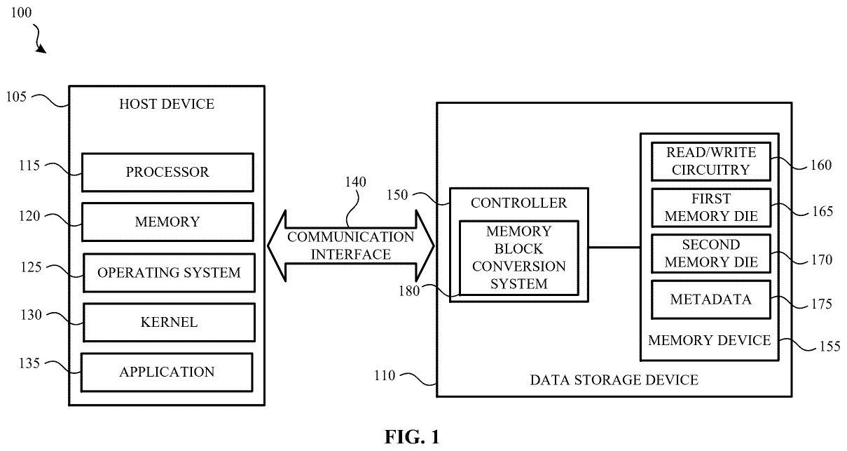

These benefits, along with other examples, will be shown and described in greater detail with respect to FIG. 1-FIG. 10.

FIG. 1 is a block diagram of a system 100 that includes a host device 105 and a data storage device 110 according to an example. In an example, the host device 105 includes at least one processor 115 and a memory 120 (e.g., main memory). The memory 120 includes or is otherwise associated with an operating system 125, a kernel 130 and/or an application 135.

The processor 115 can execute various instructions, such as, for example, instructions from the operating system 125 and/or the application 135. The processor 115 may include circuitry such as a microcontroller, a Digital Signal Processor (DSP), an Application-Specific Integrated Circuit (ASIC), a Field Programmable Gate Array (FPGA), hard-wired logic, analog circuitry and/or various combinations thereof. In an example, the processor 115 may include a System on a Chip (SoC).

In an example, the memory 120 can be used by the host device 105 to store data used, or otherwise executed by, the processor 115. Data stored in the memory 120 may include instructions provided by the data storage device 110 via a communication interface 140. The data stored in the memory 120 may also include data used to execute instructions from the operating system 125 and/or one or more applications 135. The memory 120 may be a single memory or may include multiple memories, such as, for example, one or more non-volatile memories, one or more volatile memories, or a combination thereof.

In an example, the operating system 125 creates a virtual address space for the application 135 and/or other processes executed by the processor 115. The virtual address space maps to locations in the memory 120. The operating system 125 also includes or is otherwise associated with a kernel 130. The kernel 130 includes instructions for managing various resources of the host device 105 (e.g., memory allocation), handling read and write requests and so on.

The communication interface 140 communicatively couples the host device 105 and the data storage device 110. The communication interface 140 may be a Serial Advanced Technology Attachment (SATA), a PCI express (PCIe) bus, a Small Computer System Interface (SCSI), a Serial Attached SCSI (SAS), Ethernet, Fibre Channel, or Wi-Fi. As such, the host device 105 and the data storage device 110 need not be physically co-located and may communicate over a network such as a Local Area Network (LAN) or a Wide Area Network (WAN), such as the internet. In addition, the host device 105 may interface with the data storage device 110 using a logical interface specification such as Non-Volatile Memory express (NVMe) or Advanced Host Controller Interface (AHCI).

The data storage device 110 includes at least one controller 150 and at least one memory device 155. The controller 150 may be communicatively coupled to the memory device 155. In an example, the data storage device 110 may include multiple controllers and/or multiple memory devices. In such an example, one controller is responsible for executing a first operation or set of operations (e.g., on a first memory device) and a second controller is responsible for executing a second operation or set of operations (e.g., on the first memory device or the second memory device).

In an example, the memory device 155 includes one or more memory dies (e.g., first memory die 165 and second memory die 170). Although two memory dies are shown, the memory device 155 may include any number of memory dies (e.g., one memory die, two memory dies, eight memory dies, or another number of memory dies). Additionally, although memory dies are specifically mentioned, the memory device 155 may include any non-volatile memory device, storage device, storage elements or storage medium including NAND flash memory cells and/or NOR flash memory cells.

In an example, one or more of the first memory die 165 and the second memory die 170 include one or more memory blocks. In an example, each memory block includes one or more memory cells. A block of memory cells is the smallest number of memory cells that are physically erasable together. The memory cells can be one-time programmable, few-time programmable, or many-time programmable. Additionally, the memory cells may be single-level cells (SLCs), multi-level cells (MLCs), triple-level cells (TLCs), quad-level cells (QLCs), penta-level cells (PLCs), and/or use any other memory technologies. The memory cells may be arranged in a two-dimensional configuration or a three-dimensional configuration.

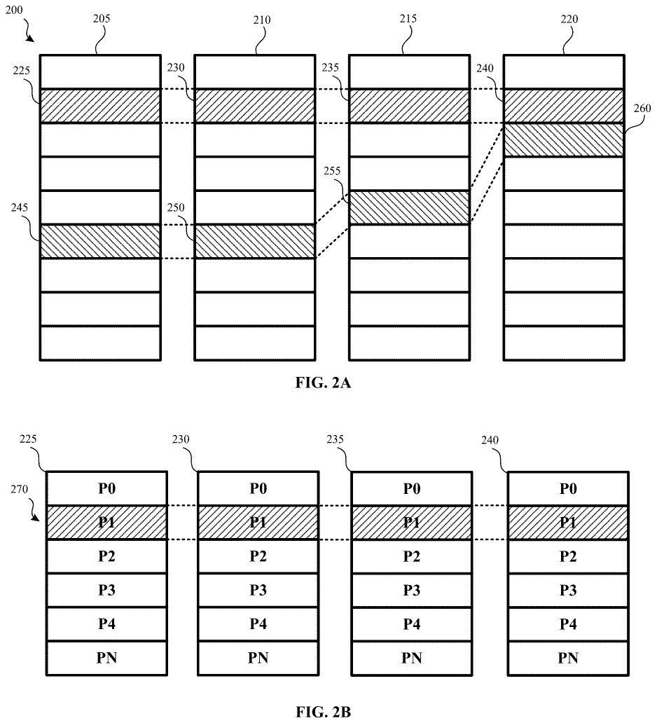

FIG. 2A illustrates how a memory device 200 includes a number of memory blocks according to an example. In this example, the memory device 200 (e.g., a storage element, a memory die, a non-volatile memory device) includes four planes or sub-arrays (e.g., a first plane 205, a second plane 210, a third plane 215, and a fourth plane 220). In an example, the planes are integrated on a single memory die. In another example, the planes are provided on two different memory dies (e.g., two planes on each memory die). In yet another example, the planes are provided on four separate memory dies. Although four planes are shown and described, the memory device 200 may have any number of planes and/or memory dies.

In an example, each plane is divided into memory blocks consisting of memory cells. As shown in FIG. 2A, the rectangles represent a memory block, such as memory block 225, memory block 230, memory block 235 and memory block 240. There may be any number of memory blocks in each plane of the memory device 200. In an example, each memory block is a unit of erase and is sometimes referred to as an erase block. For example, memory block 225, memory block 230, memory block 235 and memory block 240 include a minimum number of memory cells that are erased together.

In an example, various memory blocks are logically linked or grouped together (e.g., using a table in, or otherwise accessible by, the controller 150 (FIG. 1)) to form a metablock. A metablock is written to, read from and/or erased as a single unit. For example, memory block 225, memory block 230, memory block 235 and memory block 240 form a first metablock while memory block 245, memory block 250, memory block 255 and memory block 260 form a second metablock. The memory blocks used to form a metablock need not be restricted to the same relative locations within their respective planes.

As previously described, each memory block is divided, for operational purposes, into pages of memory cells. For example and referring to FIG. 2B, FIG. 2B illustrates how a memory block includes one or more pages according to an example. For example, the memory cells of memory block 225, memory block 230, memory block 235 and memory block 240 are divided into N different pages (shown as P0-PN). Although a specific number of pages are shown in FIG. 2B, a memory block may have any number of pages of memory cells. Further, a memory block, such as a TLC memory block, may include an upper page, a middle page and a lower page.

In an example, a page is a unit of data programming within the memory block. Each page includes the minimum amount of data that can be programmed at one time. The minimum unit of data that can be read at one time may be less than a page. For example, each page is further dividable into segments or units and each segment includes the fewest number of memory cells that may be written to at one time as a basic programming operation.

A metapage 270 is illustrated in FIG. 2B as being formed of one physical page from each of memory block 225, memory block 230, memory block 235 and memory block 240. In the example, shown, the metapage 270 includes page P1 in each of the four memory blocks. However, the pages of the metapage 270 need not have the same relative position within each of the memory blocks. A metapage 270 may be the maximum unit of programming within a memory block.

The memory blocks disclosed in FIG. 2A-FIG. 2B are referred to herein as physical memory blocks because they relate to groups of physical memory cells. A logical memory block is a virtual unit of address space defined to have the same size as a physical memory block. Each logical memory block includes a range of logical memory block addresses (LBAs) that are associated with data received from a host. The LBAs are then mapped to one or more physical memory blocks in a data storage device where the data is physically stored.

Referring back to FIG. 1, in an example, the data storage device 110 and/or the memory device 155 includes, or is otherwise associated with, different types of memory blocks. For example, each of the first memory die 165 and the second memory die 170 may include SLC memory blocks, TLC memory blocks and/or hybrid memory blocks. Although TLC memory blocks are specifically mentioned, each memory die can include MCL memory blocks, QLC memory blocks and/or PLC memory blocks.

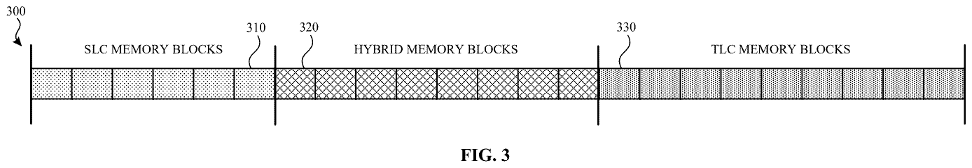

For example, and referring to FIG. 3, FIG. 3 illustrates a memory device 300 having different types of memory blocks according to an example. In an example, the memory device 300 is similar to the memory device 155 shown and described with respect to FIG. 1. As previously indicated, the memory device 300 includes a first type of memory block, such as, for example, SLC memory blocks 310. The memory device 300 also includes a second type of memory block, such as, for example, hybrid memory blocks 320. The memory device 300 can also include a third type of memory block, such as, for example, TLC memory blocks 330. The hybrid memory blocks 320 can operate in a first mode or can operate as a first type of memory block (e.g., operate in a hSLC mode or operate as a SLC memory block) and operate in a second mode or operate as a second type of memory block (e.g., operate in a TLC mode or operate as a TLC memory block).

Referring back to FIG. 1, in some examples, the data storage device 110 is attached to, or embedded within, the host device 105. In another example, the data storage device 110 may be implemented as an external device or a portable device that can be communicatively or selectively coupled to the host device 105. In yet another example, the data storage device 110 is a component (e.g., a solid-state drive (SSD)) of a network accessible data storage system, a network-attached storage system, a cloud data storage system, and the like.

The memory device 155 may also include support circuitry. In an example, the support circuitry includes read/write circuitry 160. The read/write circuitry 160 supports the operation of the memory dies of the memory device 155. Although the read/write circuitry 160 is depicted as a single component, the read/write circuitry 160 may be divided into separate components, such as, for example, read circuitry and write circuitry. The read/write circuitry 160 may be external to the memory dies of the memory device 155. In another example, one or more of the memory dies may include corresponding read/write circuitry 160 that is operable to read data from and/or write data to storage elements within one individual memory die independent of other read and/or write operations on any of the other memory dies.

The memory device 155 may also store metadata 175. The metadata 175 includes information about the memory device 155 and/or information about each of the first memory die 165 and/or the second memory die 170. For example, the metadata 175 indicates whether one or more hybrid memory blocks is operating in a first mode (e.g., a hSLC mode) or a second mode (e.g., a TLC mode).

As previously described, the data storage device 110 includes at least one controller 150. The controller 150 is communicatively coupled to the memory device 155 via a bus, an interface or other communication circuitry. In an example, the communication circuitry includes one or more channels which enable the controller 150 to communicate with the first memory die 165 and/or the second memory die 170 of the memory device 155. In another example, the communication circuitry includes multiple distinct channels which enables the controller 150 to communicate with the first memory die 165 independently and/or in parallel with the second memory die 170 of the memory device 155.

The controller 150 receives data and/or instructions from the host device 105. The controller 150 also sends data to the host device 105. For example, the controller 150 sends data to and/or receive data from the host device 105 via the communication interface 140. The controller 150 may also send data and/or commands to, and/or receive data from, the memory device 155.

In an example, the controller 150 sends data and a corresponding write command to the memory device 155 to cause the memory device 155 to store data at a specified address of the memory device 155. In an example, the write command specifies a physical address of a portion of the memory device 155. The controller 150 may also send data and/or commands associated with one or more background scanning operations, garbage collection operations, and/or wear leveling operations. The controller 150 may also send one or more read commands to the memory device 155. In an example, the read command specifies the physical address of a portion of the memory device 155 at which the data is stored.

In an example, the controller 150 includes, or is otherwise associated with, a memory block conversion system 180. The memory block conversion system 180 may be a packaged functional hardware unit designed for use with other components/systems, a portion of a program code (e.g., software or firmware) executable by a processor or processing circuitry, or a self-contained hardware and/or software component that interfaces with other components and/or systems.

The memory block conversion system 180, along with the controller 150, is operable to store data in SLC memory blocks, in TLC memory blocks, or in hybrid memory blocks when the hybrid memory blocks are operating in either the first mode (e.g., the hSLC mode) or the second mode (e.g., the TLC mode). The memory block conversion system 180 is also operable to convert a hSLC memory block to a TLC memory block while bypassing an erase operation on the hSLC memory block and/or without requiring an erase operation to be performed on the hSLC memory block.

For example, when data is received from the host device 105, the memory block conversion system 180 and/or the controller 150 determines (e.g., based on various operating states of the data storage device 110 and/or on other factors) that the data should be stored in a hybrid memory block operating in a hSLC mode. As such, the memory block conversion system 180 and/or the controller 150 causes the data to be written in various SLC memory cells in one or more hSLC memory blocks.

In an example, each SLC memory cell in the hSLC memory block holds a single bit of data or information. When in an erased state, all of the SLC memory cells in the hSLC memory block have value of one (“1”). When programming a SLC memory cell to a value of zero (“0”), programming voltage pulses are applied to the SLC memory cell until a voltage threshold reaches a particular value.

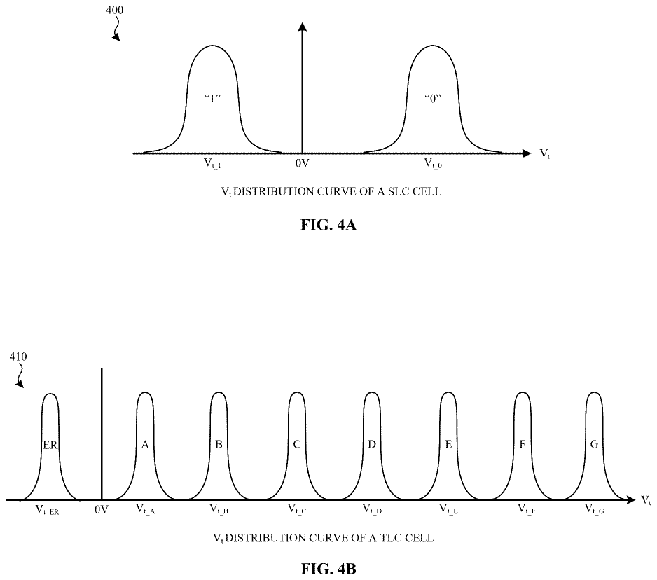

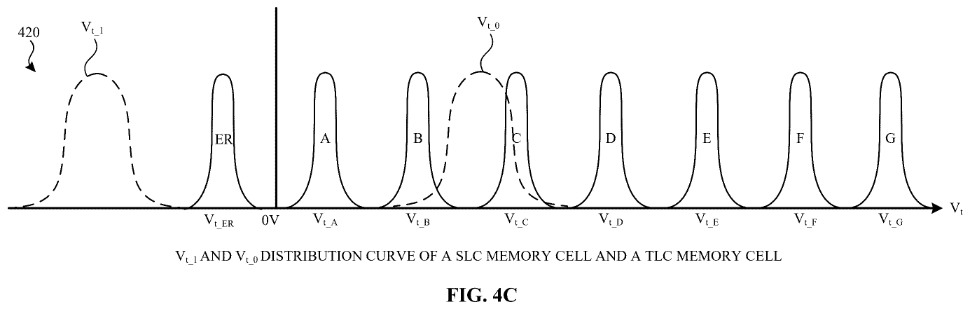

For example, and referring to FIG. 4A, FIG. 4A illustrates a voltage distribution curve 400 for a SLC memory cell according to an example. As shown in FIG. 4A, when in an erased state, a SLC memory cell has a voltage threshold (Vₜ) of V_{t_1}. That is, each SLC memory cell in the hSLC memory block has a value of “1”. As such, the voltage level V_{t_1} of the erased state is to the leftmost side of the voltage distribution curve 400. To store a “0” in a particular SLC memory cell, a programming operation applies one or more pulses to the V_{t_1} which causes the Vₜ to reach Vₜ₋₀. For example and as shown in FIG. 4A, each program pulse pushes the Vₜ distribution to the right. However, and as will be explained in greater detail herein with respect to FIG. 4C, the voltage distribution curves associated with V_{t_1} and V_{t_0} should not overlap with one or more specific voltage distribution curves that are used as part of a TLC programming operation.

Referring back to FIG. 1, once the data has been stored in one or more SLC memory cells of one or more hSLC memory blocks, the data is readable by, for example, the host device 105. That is, the memory block conversion system 180 and/or the controller 150 ensures that a complete write or programming operation has been performed on the hSLC memory blocks.

After one or more programming operations have been performed on one or more hSLC memory blocks, the data storage device 110 may receive additional data from the host device 105. As such, the memory block conversion system 180 determines to convert one or more hSLC memory blocks to one or more TLC memory blocks. As previously indicated, the memory block conversion system 180 converts the one or more hSLC memory blocks to one or more TLC memory blocks without performing, or bypassing, an erase operation.

For example, when additional data is received, the memory block conversion system 180 determines to convert a hSLC memory block to a TLC memory block. As part of the conversion process, the memory block conversion system 180 reads the data stored in a SLC memory cell and provides or stores the data in a first latch associated with a TLC memory block or memory cell. In an example, the first latch is associated with an upper page of a TLC memory cell of a TLC memory block. The memory block conversion system 180 also reads the additional data (e.g., from a cache) and stores the additional data in a second latch associated the TLC memory block and a third latch associated with the TLC memory block. In an example, the second latch is associated with a middle page of the TLC memory cell of the TLC memory block and the third latch is associated with a lower page of the TLC memory cell of the TLC memory block.

When the data from the hSLC memory block has been stored in the first latch and the additional data has been stored in the second latch and the third latch, the memory block conversion system performs a TLC programming operation to store the data in the latches to the TLC memory block. In an example, the TLC programming operation is performed using information in an encoding table. The TLC programming operation, along with encoding table, will be described in greater detail with respect to FIG. 6.

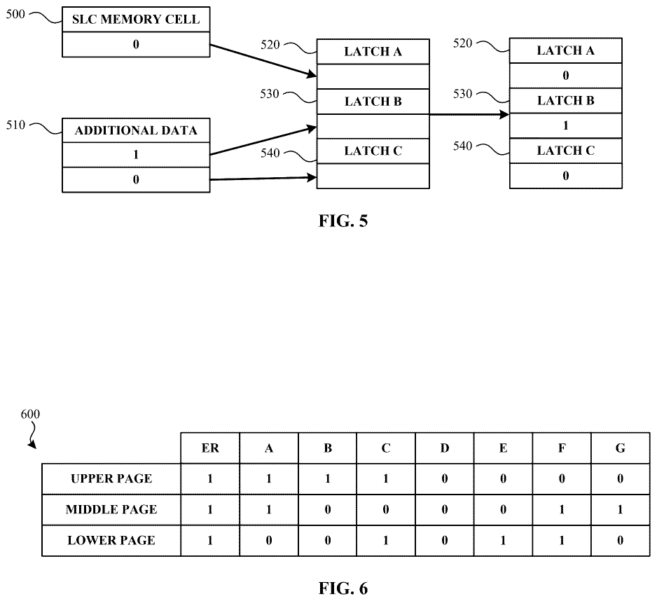

For example and referring to FIG. 5, FIG. 5 illustrates data from a SLC memory cell and additional data being stored in various latches associated with a TLC memory block according to an example. In this example, the SLC memory cell 500 stores a bit value of “0” and the additional data 510 that is received and stored in a cache has a value of “1” and “0” respectively.

Accordingly, the memory block conversion system 180 (FIG. 1) reads the “0” from the SLC memory cell 500 and stores the value in Latch A 520. Likewise, the memory block conversion system 180 reads the “1” and the “0” bit values from the additional data 510 and stores the “1” and the “0” bit values in Latch B 530 and Latch C 540 respectively. Accordingly, and as shown in FIG. 5, Latch A 520 includes a “0” bit value, Latch B 530 includes a “1” bit value and Latch C 540 includes a “0” bit value. In an example, the operations described above may be performed any number of times on a number of different SLC memory cells and/or hSLC memory blocks.

The memory block conversion system 180 will then initiate and/or perform a programming operation to convert the hSLC memory block to a TLC memory block. In an example, the memory block conversion system 180 converts the hSLC memory block to the TLC memory block by shifting (e.g., to the right) the initial programming voltage (e.g., the programming voltage that was used during a programming or write operation on the hSLC memory block) to a second programming voltage. The various programming voltages that are used to perform the conversion, and an encoding table associated with the voltages, are described in greater detail below.

Unlike a hSLC memory block that holds a single bit of data, a TLC memory block holds three bits of data. All three bits of data should be available when a TLC memory cell is programmed. For example, if three bits of information (e.g., 3′bxyz) is stored in the a TLC memory cell, x is stored in an upper page, y is stored in a middle page and z is stored in a lower page.

In an example, the TLC programming operation uses finer voltage increments with more steps when compared with the SLC programming operation. As a result, the TLC Vₜ distribution curves are sharper with smaller standard deviation.

For example, and referring to FIG. 4B, FIG. 4B illustrates a voltage distribution curve 410 for a TLC memory cell according to an example. Because a TLC memory cell stores three bits, the TLC voltage distribution curve 410 includes eight total peaks. An erased state (“ER”) represents a binary number 3′b111. That is, each of the upper page, the middle page and the lower page of the TLC memory cell in the TLC memory block stores a value of “1”. Additionally, and as shown in FIG. 4B, the voltage level V_{t_ER} of the erased state is to the leftmost side of the TLC voltage distribution curve 410.

The remaining seven peaks of the TLC voltage distribution curve 410 represent the seven remaining bit combinations. For example, voltage distribution curve A (V_{t_A}) represents a binary number 3′b110, voltage distribution curve B (V_{t_B}) represents a binary number 3′b100, voltage distribution curve C (V_{t_C}) represents a binary number 3′b101, voltage distribution curve D (V_{t_D}) represents a binary number 3′b000, voltage distribution curve E (V_{t_E}) represents a binary number 3′b001, voltage distribution curve F (V_{t_F}) represents a binary number 3′b011 and voltage distribution curve G (V_{t_G}) represents a binary number 3′b010. Although specific curves and binary numbers are shown and described, these are for example purposes only.

Thus, and in order to store different values in one or more of the upper page, the middle page and the lower page of a particular TLC memory cell, a programming operation applies one or more pulses to the V_{t_ER} which causes the Vₜ to reach the desired voltage level. For example, if the data to be stored in the TLC memory cell is 3′b101, a programming operation would occur in which a voltage V_{t_C} is applied to a particular memory cell.

However, when converting a hSLC memory block to a TLC memory block, the memory block conversion system 180 (FIG. 1) determines the first voltage level that was used to originally write or program the hSLC memory block and shifts the original voltage level, or the first voltage level, to a second voltage level.

For example, and referring to FIG. 4C, FIG. 4C illustrates a combined voltage distribution curve 420 of SLC memory cells and TLC memory cells according to an example. As shown in FIG. 4C, the voltage levels V_{t_1} and V_{t_0} that are used to program the hSLC memory block do not overlap particular voltage levels that are used to program the TLC memory block. For example, voltage level V_{t_1} does not overlap V_{t_ER} and voltage level V_{t_0} does not overlap V_{t_D}. Thus, when appending additional data to the originally programmed hSLC memory block, the original voltage level (either V_{t_1} or V_{t_0}) can be shifted or moved to the right based on the additional bits that are appended to the originally stored bit.

Referring back to the example above, the second voltage level is based, at least in part, on a voltage distribution curve for a TLC memory cell such as, for example, the voltage distribution curve 410 shown and described with respect to FIG. 4B. Additionally, the memory block conversion system 180 determines which voltage level in the voltage distribution curve 410 should be used based, at least in part, on an encoding table such as, for example, the encoding table 600 shown and described with respect to FIG. 6.

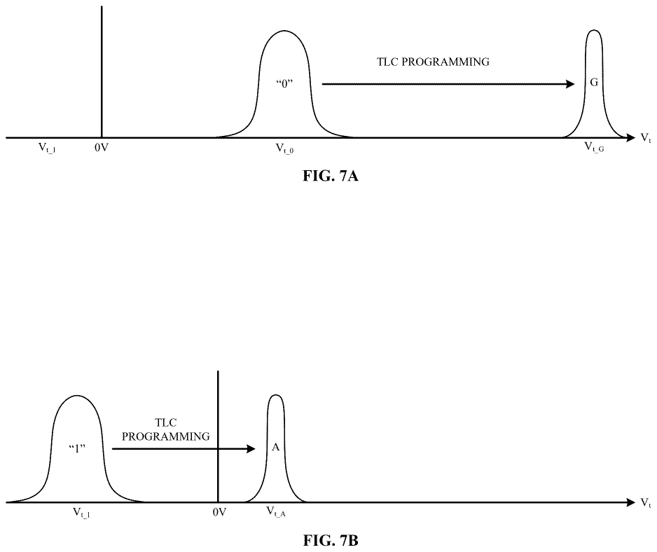

For example, if the SLC memory cell (e.g., the SLC memory cell 500 (FIG. 5)) is storing a “0” and the additional data (e.g., the additional data 510) is a “1” and a “0” respectively, the memory block conversion system 180 (FIG. 1) would check the encoding table 600 to determine which voltage is needed for the TLC programming operation. For example, the memory block conversion system 180 wants to store 2′b10 to the SLC memory cell while converting it to TLC. In this case, the combined three-bit value is 3′b010. As shown in the encoding table 600, 3′b010 corresponds to Vₜ position G. Thus, after the programming operation, the Vₜ curve shifts to the right such as shown in FIG. 7A. That is, V_{t_0} shifts to V_{t_G}.

In another example, SLC memory cell contains a “1”. In this example, the additional data includes “1” and a “0” (e.g., 2′b10). When the memory block conversion system 180 adds the additional data to the SLC memory cell while converting it to a TLC memory block or TLC memory cell, the combined three-bit value is 3′b110. As shown in the encoding table 600 (FIG. 6) 3′b110 corresponds to Vₜ location A (e.g., V_{t_A}). Thus, as shown in FIG. 7B, the Vₜ curve moves to the right to position A (or V_{t_A}) after programming.

In an example, the data that was originally stored in the hSLC memory block using the first voltage is separately readable from the additional data that was stored when the hSLC memory block is converted to the TLC memory block. For example, even after the hSLC memory block is converted to the TLC memory block, the original data is readable from the upper page of the TLC memory block and the additional data is readable from the from the middle page and the lower page of the TLC memory block.

Although the encoding table 600 shows states for TLC memory blocks, the encoding table 600 can be adapted for MLC, QLC and PLC memory blocks. For example, in the top page of the QLC, the first eight states will be one and the remaining eight states will be zero. In such examples, the V_{t_0} curve of the SLC does not overlap with the Vₜ curve of the ninth state for the QLC memory blocks. If a foggy-fine mechanism is used for QLC programming, then the foggy step may be tweaked as per the current SLC bit. If the current SLC bit is one, then no change may be required in the foggy step. If the current SLC state is zero, then the programming voltages and steps in foggy step should be adjusted since the memory cell already contains some charge for the SLC bit.

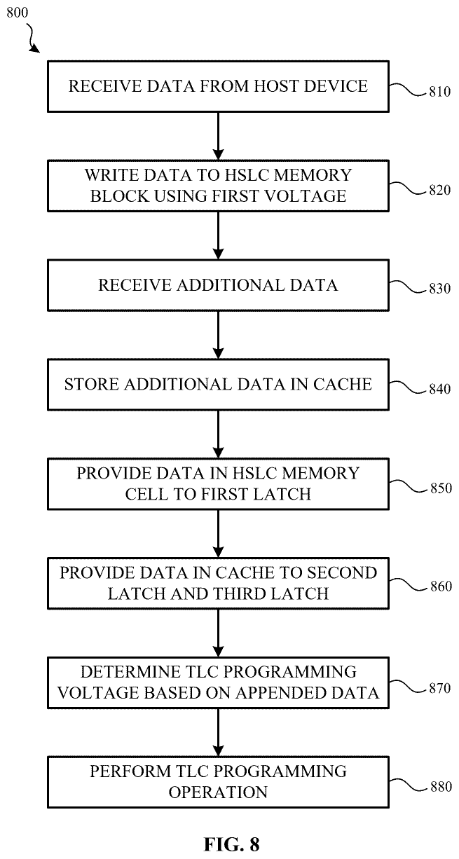

FIG. 8 illustrates a method 800 for converting a hSLC memory block to a TLC memory block without performing an erase operation according to an example. In an example, the method 800 is performed by memory block conversion system of a data storage device such as, for example, the memory block conversion system 180 shown and described with respect to FIG. 1.

In an example, the method 800 begins when data is received (810) from a host device. In an example, the data that is received from the host device may be random data or sequential data. In response to receiving the data, the memory block conversion system causes the data to be written (820) in one or more SLC memory cells of one or more hSLC memory blocks. In an example, the data is written to the hSLC memory blocks using a first programming operation and a first voltage. In an example, operations 810 and 820 may occur any number of times.

The memory block conversion system also receives (830) additional data from the host device. As with the first data, the additional data may be random data or sequential data. When the additional data is received, the memory block conversion system stores (840) the additional data in a cache of the data storage device. The memory block conversion system may then determine to convert one or more hSLC memory blocks to one or more TLC memory blocks.

As such, the memory block conversion system selects at least one hSLC memory blocks and provides (850) data stored in one or more SLC memory cells of the at least one hSLC memory block to a first latch associated with a TLC memory block. The memory block conversion system also provides (860) the additional data that is stored in the cache to a second latch and a third latch of the TLC memory block.

The memory block conversion system also determines (870) a programming voltage that is needed to represent or store the data in the converted TLC memory block. For example, if the original data and the additional data that is appended to the original data is 3′b110, the memory block conversion system determines, based on information in an encoding table, that the combined three-bit value corresponds to a particular Vₜ location (e.g., V_{t_A} (FIG. 6)). The memory block conversion system then performs (880) a second programming operation (e.g., a TLC programming operation) and shifts the Vₜ curve to the right to determined location (e.g., V_{t_A}).

In the various examples described herein, upon determining that the logical data in the hSLC memory is not invalidated (e.g., it was used for a burst performance), the controller and/or the memory block conversion system appends additional data to the hSLC memory block without an intermediate erase such as previously described. However, if the memory block conversion system determines that the logical data in the hSLC memory block is invalidated, the hSLC memory block is erased and it can be used as a new TLC memory block. Thus, the memory block conversion system can use some of the hSLC memory blocks with an erase and some hSLC memory blocks with an append to maximize a value obtained from the various examples described herein. It would further manage the encode metadata associated to the memory blocks regarding how it was used in the first place into new or existing tables such as, for example, an inverse group address table (GAT).

In some examples, such as when there are time constraints, the memory block conversion system and/or the controller can determine to store all incoming data into the hSLC memory blocks to allow time for any urgent background operations. When the time constraints are not present, the controller and/or the memory block conversion system can append additional data into the hSLC blocks by converting them into TLC blocks without performing an erase operation such as previously described.

In yet other examples, if the controller and/or the memory block conversion system determines that the P/E cycles of a memory block is more than a threshold, the memory block conversion system can switch the hSLC memory block to a TLC memory block using a standard erase and conversion operation.

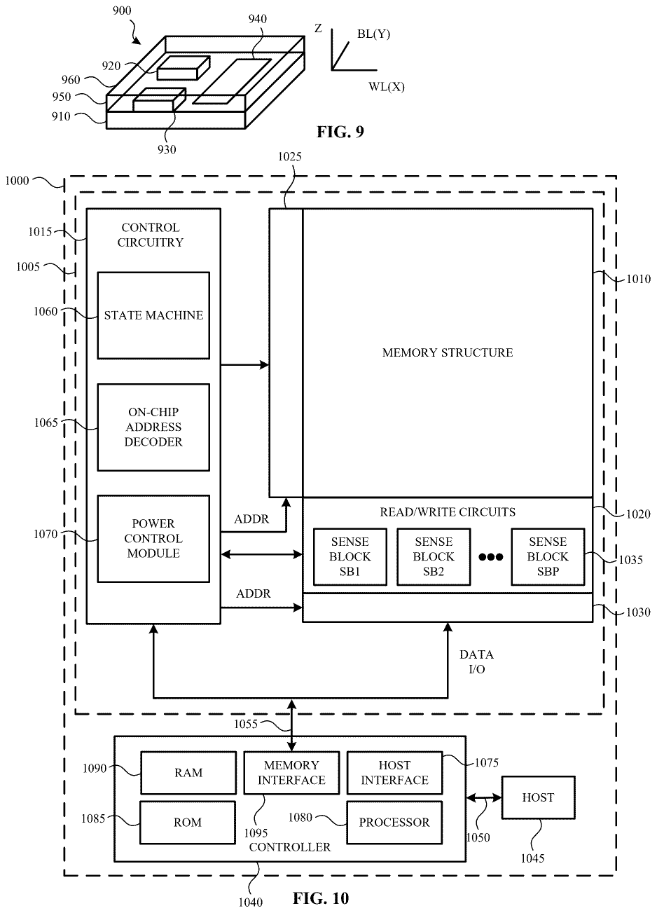

FIG. 9-FIG. 10 describe example storage devices that may be used with or otherwise implement the various features described herein. For example, the storage devices shown and described with respect to FIG. 9-FIG. 10 may include various systems and components that are similar to the systems and components shown and described with respect to FIG. 1. For example, the controller 1040 shown and described with respect to FIG. 10 may be similar to the controller 150 of FIG. 1. Likewise, the memory dies 1005 may be similar to the first memory die 165 and/or the second memory die 170 of FIG. 1.

FIG. 9 is a perspective view of a storage device 900 that includes three-dimensional (3D) stacked non-volatile memory according to an example. In this example, the storage device 900 includes a substrate 910. Blocks of memory cells are included on or above the substrate 910. The blocks may include a first block (BLK0 920) and a second block (BLK1 930). Each block may be formed of memory cells (e.g., non-volatile memory elements). The substrate 910 may also include a peripheral area 940 having support circuits that are used by the first block and the second block.

The substrate 910 may also carry circuits under the blocks, along with one or more lower metal layers which are patterned in conductive paths to carry signals from the circuits. The blocks may be formed in an intermediate region 950 of the storage device 900. The storage device may also include an upper region 960. The upper region 960 may include one or more upper metal layers that are patterned in conductive paths to carry signals from the circuits. Each block of memory cells may include a stacked area of memory cells. In an example, alternating levels of the stack represent word lines. While two blocks are depicted, additional blocks may be used and extend in the x-direction and/or the y-direction.

In an example, a length of a plane of the substrate 910 in the x-direction represents a direction in which signal paths for word lines or control gate lines extend (e.g., a word line or drain-end select gate (SGD) line direction) and the width of the plane of the substrate 910 in the y-direction represents a direction in which signal paths for bit lines extend (e.g., a bit line direction). The z-direction represents a height of the storage device 900.

FIG. 10 is a functional block diagram of a storage device 1000 according to an example. The components depicted in FIG. 10 may be electrical circuits. In an example, the storage device 1000 includes one or more memory dies 1005. Each memory die 1005 includes a three-dimensional memory structure 1010 of memory cells (e.g., a 3D array of memory cells), control circuitry 1015, and read/write circuits 1020. In another example, a two-dimensional array of memory cells may be used. The memory structure 1010 is addressable by word lines using a first decoder 1025 (e.g., a row decoder) and by bit lines using a second decoder 1030 (e.g., a column decoder). The read/write circuits 1020 may also include multiple sense blocks 1035 including SB1, SB2, . . . , SBp (e.g., sensing circuitry) which allow pages of the memory cells to be read or programmed in parallel. The sense blocks 1035 may include bit line drivers.

In an example, a controller 1040 is included in the same storage device 1000 as the one or more memory dies 1005. In another example, the controller 1040 is formed on a die that is bonded to a memory die 1005, in which case each memory die 1005 may have its own controller 1040. In yet another example, a controller die controls all of the memory dies 1005.

Commands and data may be transferred between a host 1045 and the controller 1040 using a data bus 1050. Commands and data may also be transferred between the controller 1040 and one or more of the memory dies 1005 by way of lines 1055. In one example, the memory die 1005 includes a set of input and/or output (I/O) pins that connect to lines 1055.

The memory structure 1010 may also include one or more arrays of memory cells. The memory cells may be arranged in a three-dimensional array or a two-dimensional array. The memory structure 1010 may include any type of non-volatile memory that is formed on one or more physical levels of arrays of memory cells having an active area disposed above a silicon substrate. The memory structure 1010 may be in a non-volatile memory device having circuitry associated with the operation of the memory cells, whether the associated circuitry is above or within the substrate.

The control circuitry 1015 works in conjunction with the read/write circuits 1020 to perform memory operations (e.g., erase, program, read, and others) on the memory structure 1010. The control circuitry 1015 may include registers, ROM fuses, and other devices for storing default values such as base voltages and other parameters.

The control circuitry 1015 may also include a state machine 1060, an on-chip address decoder 1065 and a power control module 1070. The state machine 1060 may provide chip-level control of various memory operations. The state machine 1060 may be programmable by software. In another example, the state machine 1060 does not use software and is completely implemented in hardware (e.g., electrical circuits).

The on-chip address decoder 1065 may provide an address interface between addresses used by host 1045 and/or the controller 1040 to a hardware address used by the first decoder 1025 and the second decoder 1030.

The power control module 1070 may control power and voltages that are supplied to the word lines and bit lines during memory operations. The power control module 1070 may include drivers for word line layers in a 3D configuration, select transistors (e.g., SGS and SGD transistors) and source lines. The power control module 1070 may include one or more charge pumps for creating voltages.

The control circuitry 1015, the state machine 1060, the on-chip address decoder 1065, the first decoder 1025, the second decoder 1030, the power control module 1070, the sense blocks 1035, the read/write circuits 1020, and/or the controller 1040 may be considered one or more control circuits and/or a managing circuit that perform some or all of the operations described herein.

In an example, the controller 1040, is an electrical circuit that may be on-chip or off-chip. Additionally, the controller 1040 may include one or more processors 1080, ROM 1085, RAM 1090, memory interface 1095, and host interface 1075, all of which may be interconnected. In an example, the one or more processors 1080 is one example of a control circuit. Other examples can use state machines or other custom circuits designed to perform one or more functions. Devices such as ROM 1085 and RAM 1090 may include code such as a set of instructions. One or more of the processors 1080 may be operable to execute the set of instructions to provide some or all of the functionality described herein.

Alternatively or additionally, one or more of the processors 1080 may access code from a memory device in the memory structure 1010, such as a reserved area of memory cells connected to one or more word lines. The memory interface 1095, in communication with ROM 1085, RAM 1090, and one or more of the processors 1080, may be an electrical circuit that provides an electrical interface between the controller 1040 and the memory die 1005. For example, the memory interface 1095 may change the format or timing of signals, provide a buffer, isolate from surges, latch I/O, and so forth.

The one or more processors 1080 may issue commands to control circuitry 1015, or any other component of memory die 1005, using the memory interface 1095. The host interface 1075, in communication with the ROM 1085, the RAM 1090, and the one or more processors 1080, may be an electrical circuit that provides an electrical interface between the controller 1040 and the host 1045. For example, the host interface 1075 may change the format or timing of signals, provide a buffer, isolate from surges, latch I/O, and so on. Commands and data from the host 1045 are received by the controller 1040 by way of the host interface 1075. Data sent to the host 1045 may be transmitted using the data bus 1050.

Multiple memory elements in the memory structure 1010 may be configured so that they are connected in series or so that each element is individually accessible. By way of a non-limiting example, flash memory devices in a NAND configuration (e.g., NAND flash memory) typically contain memory elements connected in series. A NAND string is an example of a set of series-connected memory cells and select gate transistors.

A NAND flash memory array may also be configured so that the array includes multiple NAND strings. In an example, a NAND string includes multiple memory cells sharing a single bit line and are accessed as a group. Alternatively, memory elements may be configured so that each memory element is individually accessible (e.g., a NOR memory array). The NAND and NOR memory configurations are examples and memory cells may have other configurations.

The memory cells may be arranged in the single memory device level in an ordered array, such as in a plurality of rows and/or columns. However, the memory elements may be arrayed in non-regular or non-orthogonal configurations, or in structures not considered arrays.

In an example, a 3D memory structure may be vertically arranged as a stack of multiple 2D memory device levels. As another non-limiting example, a 3D memory array may be arranged as multiple vertical columns (e.g., columns extending substantially perpendicular to the major surface of the substrate, such as in the y direction) with each column having multiple memory cells. The vertical columns may be arranged in a two-dimensional arrangement of memory cells, with memory cells on multiple vertically stacked memory planes. Other configurations of memory elements in three dimensions can also constitute a 3D memory array.

In another example, in a 3D NAND memory array, the memory elements may be coupled together to form vertical NAND strings that traverse across multiple horizontal memory device levels. Other 3D configurations can be envisioned wherein some NAND strings contain memory elements in a single memory level while other strings contain memory elements which span through multiple memory levels. 3D memory arrays may also be designed in a NOR configuration and in a ReRAM configuration.

One of ordinary skill in the art will recognize that the technology described herein is not limited to a single specific memory structure, but covers many relevant memory structures within the spirit and scope of the technology as described herein and as understood by one of ordinary skill in the art. One of skill in the art also will note that while the invention is described in terms of SLC and TLC memory blocks, other types of memory blocks, such as quad-level cell (QLC) memory blocks and multi-level cell (MLC) blocks, may be substituted for TLC memory blocks.

Examples of the present disclosure describe a method, comprising: receiving first data from a host device; writing the first data to a first type of memory block using a first voltage level; receiving second data from the host device; and converting the first type of memory block to a second type of memory block while bypassing an erase operation on the first type of memory block by: determining a value of the first data in the first type of memory block; appending at least one additional value associated with the second data to the value of the first data; and writing the second data to the second type of memory block by shifting the first voltage level to a second voltage level. In an example, determining the value of the first data in the first type of memory block comprises: reading the first data; and storing the value of the first data in a first latch associated with a first page of the second type of memory block. In an example, appending at least one additional value associated with the second data to the value of the first data comprises storing the at least one additional value in a second latch associated with a second page of the second type of memory block. In an example, the second page of the second type of memory block is one of a middle page of the second type of memory block or a lower page of the second type of memory block. In an example, the first page of the second type of memory block is an upper page of the second type of memory block. In an example, the second voltage level is greater than the first voltage level. In an example, the first data is separately readable from the second data when the first type of memory block is converted to the second type of memory block. In an example, a curve of the first voltage level is non-overlapping with a curve of the second voltage level when the first voltage level is used to program a particular value and the second voltage level is used to program the particular value. In an example, the second voltage level is defined by an encoding table.

Examples also describe a data storage device, comprising: a controller; and a memory block conversion system associated with the controller and operable to: write data to a memory block operating in a first mode using a first voltage level; bypass an erase operation and convert the memory block operating in the first mode to a memory block operating in a second mode, wherein the memory block conversion system converts the memory block operating in the first mode to the memory block operating in the second mode by: storing a value associated with the data in a first latch associated with the memory block operating in the second mode; storing at least one additional value associated with additional data to a second latch associated with the memory block operating in the second mode; and programming the additional data to the memory block operating in the second mode by shifting the first voltage level to a second voltage level. In an example, the second voltage level is defined by an encoding table. In an example, the first latch is associated with a first page of the memory block operating in the second mode. In an example, the second latch is associated with one of a second page of the memory block operating in the second mode or a third page of the memory block operating in the second mode. In an example, the data is separately readable from the additional data after the memory block operating in the first mode is converted to the memory block operating in the second mode. In an example, the second voltage level is greater than the first voltage level. In an example, the memory block operating in the first mode is a hybrid single-level cell (hSLC) memory block and wherein the memory block operating in the second mode is selected from a group of memory blocks comprising a multi-level cell (MLC) memory block, a triple-level cell (TLC) memory block, a quad-level cell (QLC) memory block, and a penta-level cell (PLC) memory block.

Examples also describe a data storage device, comprising: means for receiving first data from a host device; means for writing the first data to a first type of memory block using a first voltage level; means for receiving second data from the host device; and means for converting the first type of memory block to a second type memory block while bypassing an erase operation on the first type of memory block, the means for converting comprising: means for determining a value of the first data in the first type of memory block; means for appending at least one additional value associated with the second data to the value of the first data; and means for writing the second data to the second type of memory block, the means for writing being operable to shift the first voltage level to a second voltage level. In an example, the second voltage level is defined by an encoding table. In an example, the means for appending the at least one additional value associated with the second data to the value of the first data appends at least on page that is associated with the second data to at least one page that is associated with the first data. In an example, the first data is separately readable from the second data after the first type of memory block is converted to the second type of memory block.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks. Additionally, it is contemplated that the flowcharts and/or aspects of the flowcharts may be combined and/or performed in any order.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

1. A method, comprising:
receiving first data from a host device;
writing the first data to a first type of memory block using a first voltage level;
receiving second data from the host device; and
converting the first type of memory block to a second type of memory block while bypassing an erase operation on the first type of memory block by:
determining a value of the first data in the first type of memory block;
appending at least one additional value associated with the second data to the value of the first data; and
writing the second data to the second type of memory block by shifting the first voltage level used to write the first data to a second voltage level according to a predefined encoding scheme, the second voltage level representing a combined value of the value of the first data and the at least one additional value.

2. The method of claim 1, wherein determining the value of the first data in the first type of memory block comprises:
reading the first data; and
storing the value of the first data in a first latch associated with a first page of the second type of memory block.

3. The method of claim 2, wherein appending at least one additional value associated with the second data to the value of the first data comprises storing the at least one additional value in a second latch associated with a second page of the second type of memory block.

4. The method of claim 3, wherein the second page of the second type of memory block is one of a middle page of the second type of memory block or a lower page of the second type of memory block.

5. The method of claim 2, wherein the first page of the second type of memory block is an upper page of the second type of memory block.

6. The method of claim 1, wherein the second voltage level is greater than the first voltage level.

7. The method of claim 1, wherein the first data is separately readable from the second data when the first type of memory block is converted to the second type of memory block.

8. The method of claim 1, wherein a curve of the first voltage level is non-overlapping with a curve of the second voltage level when the first voltage level is used to program a particular value and the second voltage level is used to program the particular value.

9. (canceled)

10. A data storage device, comprising:
a controller; and
a memory block conversion system associated with the controller and operable to:
write data to a memory block operating in a first mode using a first voltage level;
bypass an erase operation and convert the memory block operating in the first mode to a memory block operating in a second mode, wherein the memory block conversion system converts the memory block operating in the first mode to the memory block operating in the second mode by:
storing a value associated with the data in a first latch associated with the memory block operating in the second mode;
storing at least one additional value associated with additional data to a second latch associated with the memory block operating in the second mode; and
programming the additional data to the memory block operating in the second mode by shifting the first voltage level used to write the data to a second voltage level according to a predefined encoding scheme, the second voltage level representing a combined value of the value associated with the data and the at least one additional value.

11. (canceled)

12. The data storage device of claim 10, wherein the first latch is associated with a first page of the memory block operating in the second mode.

13. The data storage device of claim 10, wherein the second latch is associated with one of a second page of the memory block operating in the second mode or a third page of the memory block operating in the second mode.

14. The data storage device of claim 10, wherein the data is separately readable from the additional data after the memory block operating in the first mode is converted to the memory block operating in the second mode.

15. The data storage device of claim 10, wherein the second voltage level is greater than the first voltage level.

16. The data storage device of claim 10, wherein the memory block operating in the first mode is a hybrid single-level cell (hSLC) memory block and wherein the memory block operating in the second mode is selected from a group of memory blocks comprising a multi-level cell (MLC) memory block, a triple-level cell (TLC) memory block, a quad-level cell (QLC) memory block, and a penta-level cell (PLC) memory block.

17. A data storage device, comprising:
means for receiving first data from a host device;
means for writing the first data to a first type of memory block using a first voltage level;
means for receiving second data from the host device; and
means for converting the first type of memory block to a second type of memory block while bypassing an erase operation on the first type of memory block, the means for converting comprising:
means for determining a value of the first data in the first type of memory block;
means for appending at least one additional value associated with the second data to the value of the first data; and
means for writing the second data to the second type of memory block, the means for writing being operable to shift the first voltage level used to write the first data to a second voltage level according to a predefined encoding scheme, the second voltage level representing a combined value of the value of the first data and the at least one additional value.

18. (canceled)

19. The data storage device of claim 17, wherein the means for appending the at least one additional value associated with the second data to the value of the first data appends at least one page that is associated with the second data to at least one page that is associated with the first data.

20. The data storage device of claim 17, wherein the first data is separately readable from the second data after the first type of memory block is converted to the second type of memory block.

21. The method of claim 1, wherein shifting the first voltage level used to write the first data to the second voltage level comprises increasing a threshold voltage of a memory cell that retains the first data from the first voltage level to the second voltage level.

22. The method of claim 1, wherein the value of the first data is a most significant bit of the combined value and the at least one additional value comprises one or more lower-order bits of the combined value.

23. The method of claim 1, wherein the second voltage level is determined by identifying, in the predefined encoding scheme, an entry corresponding to the combined value formed by the value of the first data and the at least one additional value.
